(19) United States
(12) Patent Application Publication
(10) Pub. No.: US 2011/0100765 A1
(43) Pub. Date: May 5, 2011

(54) WHEEL CHOCK HAVING A ROLLER ASSIST

(76) Inventors: Steve K. Bird, St. Louis, MO (US); Robert Bales, St. Louis, MO (US)

(21) Appl. No.: 12/611,794

(22) Filed: Nov. 3, 2009

(51) Int. Cl. B60T 3/00; B62B 1/02

(52) U.S. Cl. 188/32; 280/47.24

(57) ABSTRACT

A wheel chock having a roller assist comprised of a chock, a handle assembly, and a roller assembly. The wheel chock is controlled and lifted by the handle assembly pivoting on the roller assembly. The roller assembly allows rolling of the chock by a user without the necessity of actually lifting the chock. The preferred embodiment utilizes a chock of a heavy and structurally strong rubber or rubber like laminated belting material. The belting material provides an assured grip with the underlying pavement and also forms a structure which is substantially indestructible by a vehicle or a truck.

### BACKGROUND OF THE INVENTION

The art of the present invention relates to wheel chocks in general and more particularly to a wheel chock and method of use having one or more rollers or dollies and an extending handle or arm which allows a user to easily place the chock behind a wheel without the usual bending, stooping, or kneeling required with prior art chock devices. The art of the present invention is especially useful for persons having disabilities or other ailments which limit their ability to bend, stoop, or kneel.

Wheel chocks (i.e. chocks) are generally wedge shaped structures of a sturdy (and generally heavy) material which are typically placed behind one or more vehicle's wheels in order to prevent accidental vehicle movement and promote safety. The bottom surface often has a coating or is manufactured from a material that enhances the grip with the pavement, ground, or floor beneath the chock. The coefficient of static friction of the bottom surface dictates that if the chock is of a greater mass, the force required to slip the chock out of position will be greater. (i.e. the greater the chock mass, the less chance of slippage and undesired vehicle movement) For ease of removal, the prior art often utilizes a rope tied to the chock which may be pulled to remove the chock. Often the prior art utilizes a concave profile on the wheel contacting surface of the wedge in order to contour to the wheel and increase the force necessary to overrun the chock.

Wheel chocks are regularly utilized during the loading and unloading of trucks and tractor-trailers. The sheer weight of the aforesaid vehicles requires that the chock be manufactured from a durable and generally heavy material in order to minimize the probability of chock deformation and vehicle movement. Unfortunately, wheel chocks having the required durability are often so heavy that they cannot be easily placed under or mated with the wheels of a vehicle by a single user without undue stresses placed upon the user.

The prior art attempts to address this issue in U.S. Pat. No. 6,390,245 B1 issued to Metz on May 21, 2002. Metz places a handle onto a lightweight honeycomb material chock in order to facilitate placement of the chock. The art of Metz is designed to be lifted by the user and, by necessity, requires that the chock be of a lightweight material. Unfortunately, a lightweight chock is generally not as sturdy or as likely to inhibit the vehicle from moving.

The present art represents a heavy and durable wheel chock having a handle and roller assembly which allows the user to easily roll the chock into a mating position under a vehicle wheel and remove the chock when required. The present art does not require the user to physically lift the chock during use. This allows the chock to be manufactured a heavy and durable material and thereby provide the optimum benefits.

Accordingly, it is an object of the present invention to provide a wheel chock having a roller assist which maximizes chock strength, weight, and retention ability while minimizing user inconvenience.

Another object of the present invention is to provide a wheel chock having a roller assist with a roller assembly and handle which allows a user to easily place the chock without bending, stooping, or kneeling.

A further object of the present invention is to provide a wheel chock having a roller assist which also has a chain or cable attachment assembly for securely attaching the chock to a building or other non-movable structure in order to prevent theft.

### SUMMARY OF THE INVENTION

In its preferred form, the art of the present invention represents a chock in the form of a generally wedge shaped structure with a wheel contacting surface, a bottom surface, a front surface, a proximal surface, and a distal surface. The preferred embodiment utilizes a wedge shape of approximately eight inches in width and height which is formed from a laminated rubber or rubber like material. The rubber or rubber like material maximizes the coefficient of static friction with the pavement upon which the chock rests. (i.e. an approximate value of 1.0 on concrete whereas the lightweight aluminum extrusion of Metz has an approximate value less than 0.6)

For the preferred embodiment, fasteners secure the laminations together and are in the form of one or more threaded rods or bolts which extend through the laminations. Also for the preferred embodiment, one or more plates, washers, or other surface force or load distributing members are placed under the heads or nuts of the fasteners.

For the preferred embodiment, a handle assembly is attached with and extends from the proximal surface of the chock. A roller assembly having one or more rollers or a dolly assembly is attached with the handle assembly aft of the proximal surface. The roller assembly is positioned with said handle assembly such that when the chock is placed under a wheel with the bottom surface touching the pavement, the rollers are slightly elevated above the pavement. This preferred positioning assures that the rollers do not have any of the chock load upon them when the chock is placed and utilized. For the preferred embodiment, said handle assembly is welded onto the proximal surface plate load distributing member via a handle assembly coupling extending from the proximal surface.

The roller assembly preferably comprises a carriage and one or more (preferably two) rollers or wheels rotatably attached with said carriage. The carriage is preferably attached via one or more welds with the handle assembly. The user is able to lift the chock by pressing the proximal grip portion towards the pavement and thereafter roll the apparatus to a desired position.

For the preferred embodiment, the distal surface of the chock has a chain or cable attachment assembly in the form of an eyelet or “U” shaped extension extending therefrom. This allows the apparatus to be secured to a building, structure, or post in order to prevent theft and unauthorized use.

Operation of the apparatus is simple and intuitive. The user first simply disconnects the apparatus from any building, structure, or post with which it is attached. The user then presses downward (towards the pavement) upon the proximal grip portion and rolls the apparatus to a desired location such as under or behind a vehicle wheel. After use, the user simply repeats the aforesaid procedure and rolls the apparatus to a desired location. The roller assembly allows for easy and convenient placement of the chock and construction of the chock from a heavy and durable material.

The art of the present invention may be manufactured from a plurality of materials including but not limited to rubber or rubber like materials, metals and alloys thereof, polymers, composites, woods, or ceramics without departing from the scope and spirit herein intended. The apparatus may further be manufactured via molding, machining, casting, forging, pressing, laminating, carving, or utilization of stereo-lithographic or electro-dynamic milling or other techniques which are appropriate for the material utilized.

### BRIEF DESCRIPTION OF THE DRAWINGS

Numerous other objects, features, and advantages of the invention should now become apparent upon a reading of the following detailed description taken in conjunction with the accompanying drawings, in which:

FIG. 1 is a right front perspective view of a wheel chock having a roller assist;

FIG. 2 is a front view thereof;

FIG. 3 is a rear view thereof;

FIG. 4 is a left side plan view thereof;

FIG. 5 is a right side plan view thereof;

FIG. 6 is a top plan view thereof;

FIG. 7 is a bottom plan view thereof.

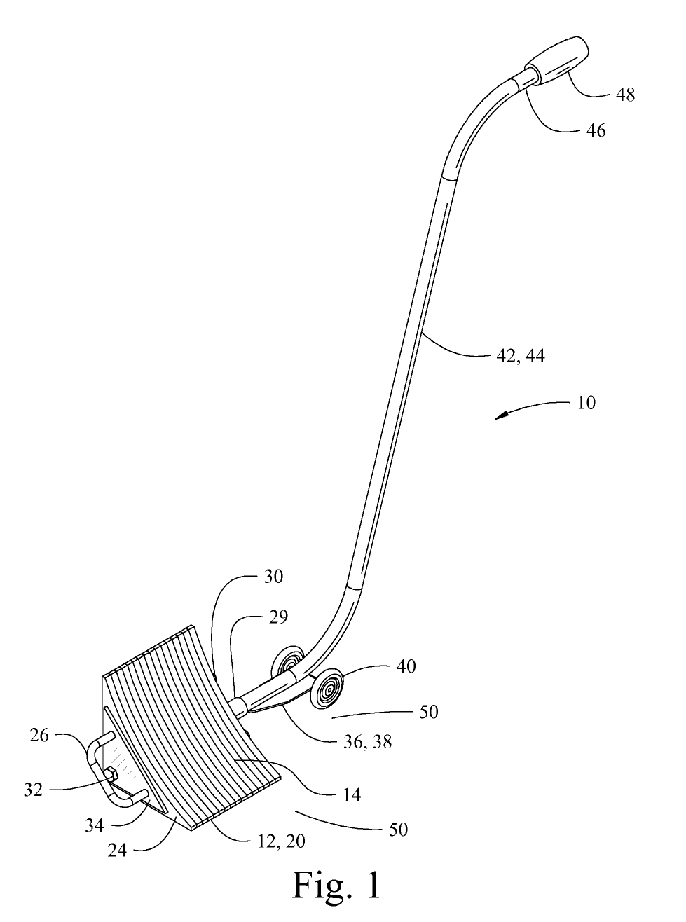

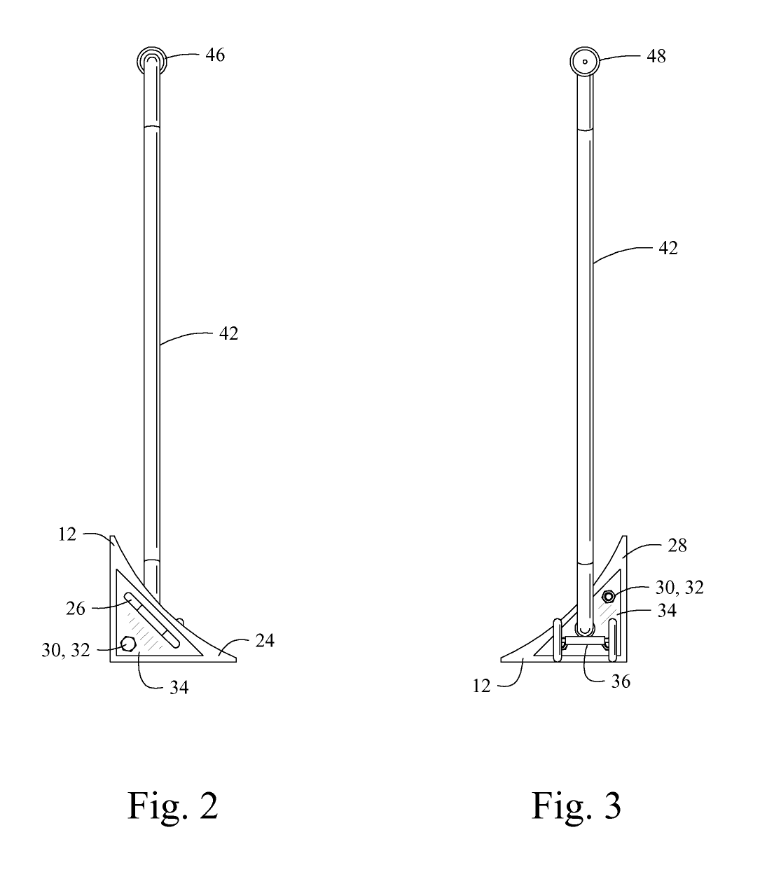

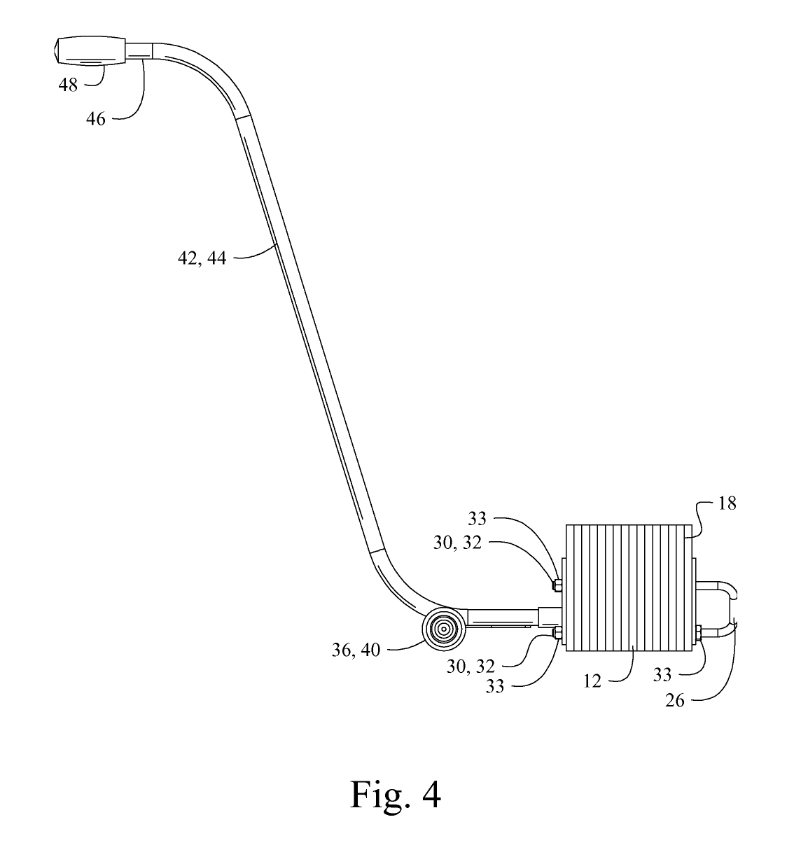

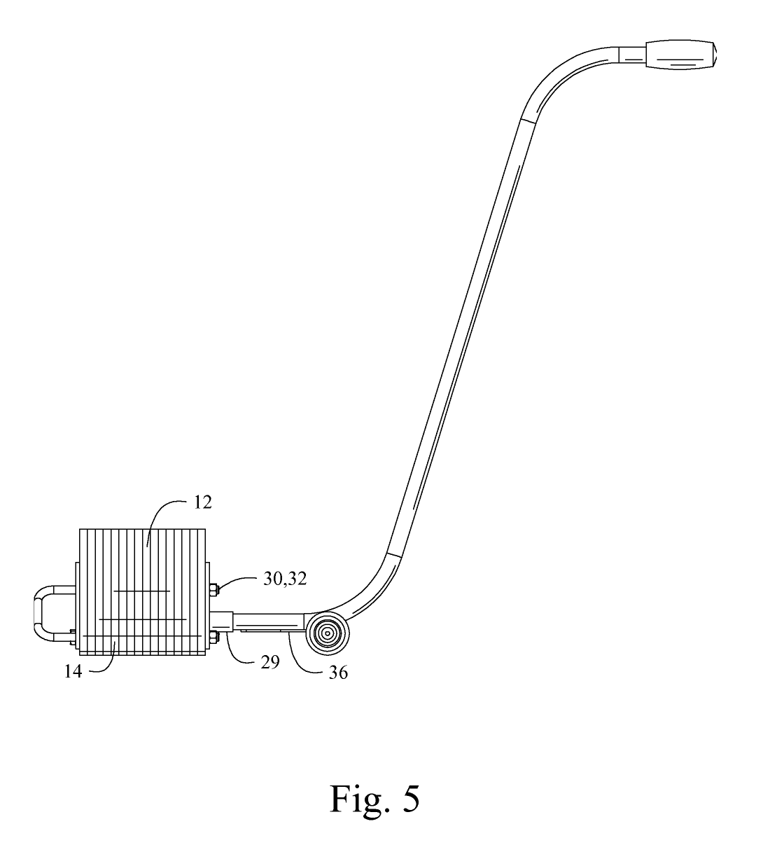

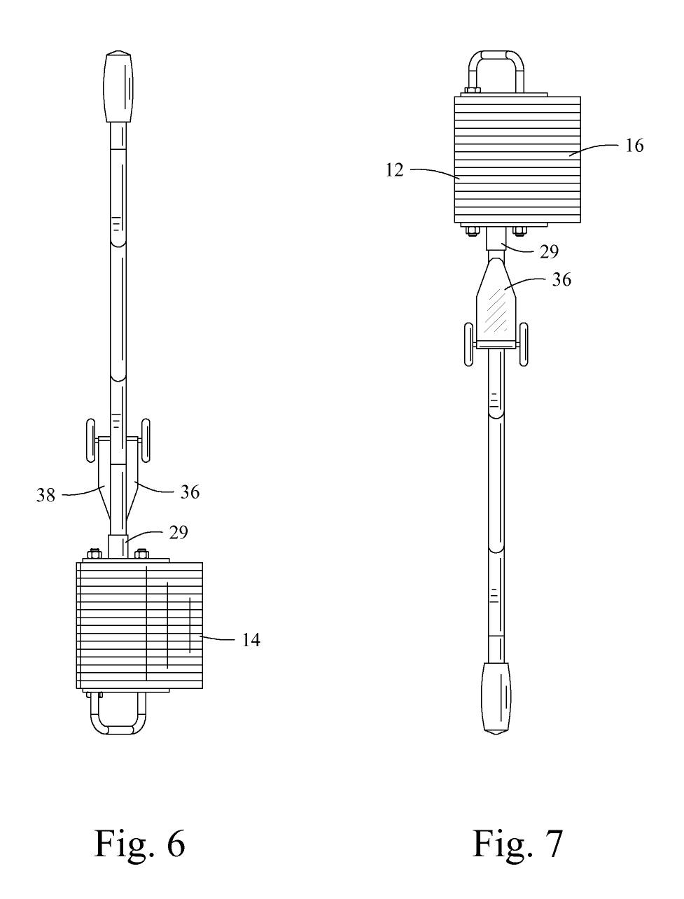

### DETAILED DESCRIPTION

Referring now to the drawings, there is shown in the Figures a preferred embodiment of a wheel chock having a roller assist 10. In its preferred form, the present art apparatus 10 comprises a chock 12, a handle assembly 42, and a roller assembly 36 upon which the entire apparatus 10 may be rolled into position.

In its preferred form, the art of the present invention represents a chock 12 in the form of a generally wedge shaped structure with a wheel contacting surface 14, a bottom surface 16, a front surface 18, a proximal surface 28, and a distal surface 24. Preferably said contacting surface 14 is contoured or shaped, i.e. a arcuate surface, to mate or touch with a vehicle wheel. For the preferred embodiment the chock 12 is formed from a laminated rubber or rubber like belting material 20 having a plurality of layers (laminations) with one or more fasteners 30 extending through the laminations 20. The fasteners 30 are capable of compressing the laminations 20 together as a solid and strong chock 12. The preferred embodiment utilizes a wedge shape of approximately eight inches in width and height with alternative embodiments utilizing a plurality of heights and widths based upon the application and user preference.

Alternative embodiments may utilize a plurality of chock 12 forms (i.e. wedge shaped, elliptical shaped, circular shaped, and rectangular shaped) and methods of manufacture, including but not limited to molding, casting, machining, and laminating. Alternative chock 12 embodiments may be manufactured from a plurality of materials, including but not limited to, polymers, composites, metals, and woods.

For the preferred embodiment, the fasteners 30 are in the form of one or more threaded rods or bolts 32 which extend through the laminations 20 and are secured via a head or a nut 33 on the proximal 28 or distal 24 surfaces. Also for the preferred embodiment, one or more plates, washers, or other surface force or load distributing members 34 are placed under said heads or nuts 33. The preferred embodiment utilizes a somewhat triangular shaped plate 34 through which said threaded rods or bolts 32 are placed and which function to fully sandwich the laminations 20 there between. Alternative embodiments may utilize a plurality of fastener 30 forms including but not limited to rivets, pins, screws, and adhesives. Alternative embodiments may also utilize a plurality of load distributing member 34 shapes or none at all based upon user desires, durability requirements, and cost constraints.

For the preferred embodiment, a handle assembly 42 is attached with or near and extends from the proximal surface 28 of the chock 12. A roller assembly 36 having one or more rollers or a dolly assembly 40 is attached with the handle assembly 42 aft (i.e. between the proximal grip portion 46 and the proximal surface 28) of the proximal surface 28 of the chock 12. Alternative embodiments may attached said roller assembly 36 with said chock 12 provided the rollers 40 are positioned aft (i.e. between the proximal grip portion 46 and the proximal surface 28) of said proximal surface 28. The roller assembly is positioned with said handle assembly 42 such that when the chock 12 is placed under a wheel with the bottom surface 16 touching the pavement 50, the rollers 40 are slightly elevated above the pavement 50. This preferred positioning assures that the rollers 40 do not have any of the chock 12 load upon them when the chock 12 is placed and utilized. For the preferred embodiment, said handle assembly 42 is attached onto the proximal surface 28 plate load distributing member 34 via a handle assembly coupling 29 extending from the proximal surface 28. In a preferred form, said coupling 29 comprises a tube of substantially equivalent inside diameter as the outside diameter of the handle assembly 42 tubular member 44. Alternative embodiments may attach said handle assembly 42 with said chock 12 in a plurality of ways including but not limited to pins, friction or press fits within said chock, screws, welds, or adhesives.

For the preferred embodiment, the handle assembly 42 is a partially “S” shaped tubular member 44 which extends from at or near the proximal surface 28 of the chock 12 to a proximal grip portion 46 of the handle assembly 42. The proximal grip portion 46 preferably has a grip 48 (i.e. similar to that found upon a bicycle handlebar) which allows the user to easily hold the handle assembly 42 and move the chock 12 on the roller assembly 36. For the preferred embodiment, the proximal grip portion 46, when the handle assembly 42 is attached with the chock 12, is approximately three feet in height and two and one half feet proximal or rearward from the proximal surface 28 of the chock 12. Alternative embodiments may utilize a handle assembly 42 of any user desirable shape or size and place the height and rearward position at any user desired position.

The roller assembly 36 preferably comprises a carriage 38 and one or more (preferably two) rollers 40 (i.e. small wheels) rotatably attached with said carriage 38. For the preferred embodiment the carriage 38 is a substantially flat plate which is attached with said handle assembly 42 on a first leg of said “S” shaped tubular member 44 near said proximal surface 28 of the chock 12. The carriage 38 is preferably attached via one or more welds but may utilize alternative techniques including but not limited to screws, pins, clamps, bands, or adhesives and may be removable. For the preferred embodiment, the rollers 40 are approximately two and three quarters inch in diameter and positioned so that the circumference is slightly above the pavement 50 when the chock 12 is placed under a wheel. That is, the circumference is positioned slightly above a plane of said bottom surface 16 whereby a weight or a force placed upon said chock 12 does not place said weight or said force upon said rollers 40. This positioning assures the user that no vehicle weight is placed upon the rollers 40 when the chock 12 is placed under the vehicle wheel. Alternative embodiments may attach the rollers 40 directly to the handle assembly 42 via a plurality of methods (i.e. holes within the handle, welds, retainers, or others methods recognized within the mechanical arts) or utilize a plurality of roller 40 diameters. The roller(s) 40 may be positioned at a plurality of positions aft of the proximal surface 28 of the chock 12 provided that the roller(s) 40 serve as a pivot axis or loci of rotation between the proximal grip portion 46 and the chock 12. That is, the user should be able to lift the chock 12 by pressing the proximal grip portion 46 towards the pavement 50 and thereafter roll the apparatus 10 to a desired position.

For the preferred embodiment, the distal surface 24 of the chock 12 has a chain or cable attachment assembly 26 in the form of an eyelet or “U” shaped extension extending therefrom. This allows the apparatus 10 to be secured to a building, structure, or post in order to prevent theft and unauthorized use. Also for the preferred embodiment, the attachment assembly 26 is formed from approximately ½ inch steel rod, bent into a “U” shaped form, and threaded with two of the fasteners 30 extending through the chock 12. Alternative embodiments may utilize attachment assemblies 26 having a plurality of forms which are integral with or external to the chock 12 provided the attachment assembly 26 is capable of securing the chock 12.

Operation of the apparatus 10 is simple and intuitive. The user first simply disconnects the apparatus 10 from any building, structure, or post with which it is attached. The user then presses downward (towards the pavement 50) upon the proximal grip portion 46 and rolls the apparatus 10 to a desired location such as under or behind a vehicle wheel. After use, the user simply repeats the aforesaid procedure and rolls the apparatus 10 to a desired location. The roller assembly 36 allows for easy and convenient placement of the chock 12 and construction of the chock 12 from a heavy and durable material.

Although described for enablement purposes, the lengths, widths, and other dimensional attributes may depart significantly from those specified. The shape, size, location, component numbers and mounting methods utilized for each of the components or constituent elements may take a plurality of forms as recognized within the pertinent arts without departing from the scope and spirit of the present invention.

Having described the invention in detail, those skilled in the art will appreciate that modifications may be made to the invention and its method of use without departing from the spirit herein identified. Therefore, it is not intended that the scope of the invention be limited to the specific embodiments illustrated and described. Rather, it is intended that the scope of this invention be determined by the appended claims and their equivalents.

What is claimed is:

1. A wheel chock having a roller assist comprising:
a chock having a wheel contacting surface, a bottom surface, a front surface, a proximal surface, and a distal surface; and
a handle assembly having a proximal grip portion and said handle assembly attached with said chock and substantially extending from said proximal surface; and
a roller assembly having one or more rollers attached to said handle assembly or said chock and said one or more rollers positioned between said proximal grip portion and said proximal surface; and
said rollers having a circumference which is positioned slightly above a plane of said bottom surface whereby a weight or a force placed upon said chock does not substantially place said weight or said force upon said rollers.

2. The wheel chock having a roller assist comprising as set forth in claim 1, whereby:
said chock comprises one or more laminations of a rubber or rubber like material; and
one or more fasteners extending through said laminations whereby said fasteners are capable of solidly and strongly compressing said laminations together as said chock.

3. The wheel chock having a roller assist as set forth in claim 2, whereby:
said fasteners comprise one or more threaded rods or bolts; and
one or more plates positioned with said proximal or distal surfaces through which one or more of said fasteners compress said laminations.

4. The wheel chock having a roller assist as set forth in claim 2, further comprising:
an chain or cable attachment assembly in the form of an eyelet or “U” shaped extension attached with said distal surface.

5. The wheel chock having a roller assist as set forth in claim 3, whereby:
said handle assembly is a partially “S” shaped tubular member having a grip on at least a portion of said proximal grip portion.

6. The wheel chock having a roller assist as set forth in claim 5, further comprising:
a handle assembly coupling between said proximal surface and said handle assembly whereby said handle assembly is attached onto said proximal surface.

7. The wheel chock having a roller assist as set forth in claim 1, further comprising:
an chain or cable attachment assembly in the form of an eyelet or “U” shaped extension attached with said distal surface.

8. The wheel chock having a roller assist as set forth in claim 1, whereby:
said handle assembly is a partially “S” shaped tubular member having a grip on at least a portion of said proximal grip portion.

9. The wheel chock having a roller assist as set forth in claim 1, further comprising:
a handle assembly coupling between said proximal surface and said handle assembly whereby said handle assembly is attached onto said proximal surface.

10. A wheel chock having a roller assist comprising:
a chock having a wedge shape and a wheel contacting surface, a bottom surface, a front surface, proximal surface and a distal surface; and
a handle assembly attached with said chock and having a proximal grip portion; and
one or more rollers rotatably attached with said handle assembly or said chock; and
said rollers having a circumference positioned slightly outside of a plane of said bottom surface wherein a weight or a force placed upon said chock does not substantially place said weight or said force upon said rollers.

11. The wheel chock having a roller assist as set forth in claim 10, further comprising:
a chain or cable attachment assembly attached with said distal surface whereby a chain or cable may be placed for securing said chock.

12. The wheel chock having a roller assist as set forth in claim 10, whereby:
said chock comprises a plurality of laminations having one or more fasteners substantially extending from said proximal surface to said distal surface.

13. The wheel chock having a roller assist as set forth in claim 10, further comprising:
a handle assembly coupling placed with said proximal surface substantially between said proximal surface and said handle assembly.

14. The wheel chock having a roller assist as set forth in claim 13, whereby:
said chock comprises a plurality of laminations having one or more fasteners extending from said proximal surface to said distal surface.

15. The wheel chock having a roller assist as set forth in claim 14, further comprising:
a carriage attached with said handle assembly and said rollers and positioned between said proximal surface and said proximal grip portion.

16. The wheel chock having a roller assist as set forth in claim 15, whereby:
said handle assembly is a partially “S” shaped tubular member.

17. The wheel chock having a roller assist as set forth in claim 16, further comprising:
one or more load distributing members on said proximal or distal surface through which one or more of said fasteners are placed.
